(19) United States
(12) Patent Application Publication
(10) Pub. No.: US 2004/0179263 A1
(43) Pub. Date: Sep. 16, 2004

(54) Stereoscopic image display apparatus

(76) Inventors: Koichi Yoshikawa, Kanagawa (JP); Kiyosuke Suzuki, Tokyo (JP)

Correspondence Address: William S. Frommer, Esq., FROMMER LAWRENCE & HAUG LLP, 745 Fifth Avenue, New York, NY, 10151, US

(21) Appl. No.: 10/763,651

(22) Filed: Jan. 23, 2004

(30) Foreign Application Priority Data
Jan. 27, 2003 (JP) 2003-017888

(51) Int. Cl. G02B 27/22

(52) U.S. Cl. 359/462

(57) ABSTRACT

A 3D display apparatus of simple construction enabling many people to observe 3D images having many viewing points in a near-natural condition is provided. The apparatus includes picture image display parts, lenses forming images from the picture image display parts, and a screen diffracting and condensing picture images formed by the lenses to observing positions. The picture image display parts are arranged such that incident positions of lights, whose ray passing through the screen without changing its direction, would not coincide with the observing positions. At the picture image display part, a parallax picture image corresponding to a viewing point or an eye of an observer is displayed, and observed at corresponding observing position.

### CROSS REFERENCE TO RELATED APPLICATIONS

The present document is based on Japanese Priority Document JP 2003-017888 filed in the Japanese Patent Office on Jan. 27, 2003, the entire contents of which being incorporated herein by reference.

### BACKGROUND OF THE INVENTION

1. Field of the Invention

The present invention relates to a stereoscopic image display apparatus by using parallax.

2. Description of the Related Art

Typically, a display apparatus for displaying a stereoscopic image three-dimensionally (hereinafter referred to as “3D display apparatus”) has a display screen that is divided into very small areas, and each of these areas is assigned to either left or right eye based on a predetermined rule. A slit-shape light-shielding plate or a lenticular lens or the like may be used to present only a parallax image for the right eye in the right-eye areas, and only a parallax image for the left eye in the left-eye area, whereby making it possible to achieve a 3D display when the images are observed simultaneously by both eyes.

However, such a method produces a coarse image subjected to grid-like filter as well as flickering in the image. Further, since this requires setting up the slit-like light-shielding plates or lenticular lens or the like in front of an LCD panel or PDP panel, it is difficult to realize a screen exceeding a 200 type (200 inches).

There are other methods such as a 3D display apparatus presenting different images to the left eye and the right eye by using a polarizing filter or color filter or the like, and a head mount display (HMD) provided with different display means to the left eye and the right eye, respectively.

However, since this type of display apparatus requires the use of special apparatus such as a pair of glasses or HMD, it is difficult to use with ease. Further, an actual distance between the eye and the screen differs from a distance between the eye and an object image so that an observer suffers considerable fatigue when it is used over a long period of time.

It should be noted that a 3D display apparatus using hologram is listed below in Japanese Patent Application Publication JP H04-355747. According to a technique described therein, the observer is able to see different images for the right eye and for the left eye at the same position on the hologram screen simultaneously through the left and the right eyes. Consequently, the observer can see a 3D image in a condition close to natural condition without any flickering.

Moreover, there is a multiple viewing point image display apparatus, which makes it possible to view an image of multiple viewing points, disclosed in Japanese Patent Application Publication JP H11-190969. In a technique introduced in Japanese Patent Application Publication JP H11-190969, there is provided a plurality of specific viewing point image display devices, each device displaying an image from one viewing point. By allowing viewing of different moving images having different parallax of the same time period at spatially different positions, of these images of parallax moving images, a stereoscopic vision at the multiple viewing points is achieved by selectively providing parallax moving images proper for the left and right eyes.

### SUMMARY OF THE PRESENT INVENTION

However, in the technique described in the above-mentioned Japanese Patent Application Publication JP H04-355747, the image cannot be seen if the observer moves a face position since there is only one point at which diffracted light is condensed. Accordingly, the observer's position is limited to the one point. Further, since there is only one observing position, only one person is allowed to observe a stereoscopic image, thus making it impossible for a plurality of persons to enjoy the image simultaneously. Still further, it is not possible to display a plurality of images having different viewing points simultaneously on one display apparatus. Moreover, although the technique described in the above-mentioned Japanese Patent Application Publication JP H11-190969 enables viewing of images at the multiple viewing points by using a hologram, large and complicated equipment is required, and 0th light advances straight into the observer's eye without diffraction.

The present invention has been made in view of the above-mentioned circumstances. It is desirable to provide a three-dimensional display apparatus with simpler construction, which permits a large number of people to view a three-dimensional image of multiple observing points in a condition close to natural condition.

According to an embodiment of the present invention, there is provided a 3D display apparatus including: displaying means for displaying N images of different viewing points; image-forming means for forming the N images displayed by the displaying means at predetermined image-forming positions; and light-condensing means for individually condensing the images to N observing positions that correspond to the N viewing points, the light-condensing means being disposed at the image-forming positions at which the N images are formed. The light-condensing means is a transmission-type or reflection-type hologram screen having a function of diffracting and condensing images formed by the image-forming means to the N observing positions. Further, arrival positions of rays of light whose direction remains unchanged by the light-condensing means do not coincide with the observing positions.

According to the embodiment of the present invention, there is provided the light-condensing means for condensing images that are captured from N different positions to the N different observing positions which correspond the N different viewing points. Accordingly, it is possible for a large number of observers to view images of different viewing points, and, at the same time, it is possible to deviate 0th lights from the observing positions, thus enabling the observers to view high quality images.

Further, the light-condensing means may condense the images to predetermined observing positions on the predetermined observation plane. The 3D picture images may be viewed even in a depth direction if the observation plane is formed with a plurality of planes, and if each of the planes is approximately parallel to the light-condensing means with having different distance between the plane and the light-condensing means.

Still further, a gap between two observing positions of the N observing positions may be set equal or approximately equal to a gap between the eyes of a human being. Here, it is assumed that these two observing positions are positioned on the same horizontal line in the same observation plane. For example, an average gap between the eyes of a Japanese is approximately 62.5 mm. By setting the gap at this distance, it is possible for the observer, even if he moves, to view high quality 3D picture images.

According to an embodiment of the present invention, there is provided a three-dimensional display apparatus including: displaying means for displaying N images of different viewing points; image-forming means for forming the N images displayed by the displaying means at predetermined image-forming positions; and light-condensing means for individually condensing the images to N observing positions that correspond to the N viewing points, the light-condensing means being disposed at the image-forming positions at which the N images are formed. The image-forming means forms images of the N viewing points from N different positions to the light-condensing means. Further, the light-condensing means includes a recursive reflection-type screen for recursively reflecting each image formed by the image-forming means, and a half mirror for condensing the recursively reflected image to the N observing positions. The half mirror is disposed between the image-forming means and the recursive reflection-type screen.

According to the embodiment of the present invention, it is possible for a large number of people to view images at multiple viewing points. Further, by utilizing the recursive reflection, it is possible to make a apparatus smaller.

As mentioned above, the 3D display apparatus according to the embodiments of the present invention may includes displaying means for displaying N images of different viewing points; image-forming means for forming the N images displayed by the displaying means at predetermined image-forming positions; and light-condensing means for individually condensing the images to N observing positions that correspond to the N viewing points, the light-condensing means being disposed at the image-forming positions at which the N images are formed. Accordingly, the 3D picture images of multiple viewing points may be viewed at a plurality of observing positions. Further, the apparatuses according to the embodiments may be provided with a simple construction. Further, according to the embodiments of the present invention, a large number of people may be able to view 3D picture images simultaneously. Further, at the same time, it is possible to provide different 3D picture images corresponding to different viewing points when an observer moves and his/her viewing points changes in different directions such as forward, backward, left, or right.

According to an embodiment of the present invention, there is provided a three-dimensional display apparatus including: displays for displaying N images of different viewing points; lenses for forming the N images displayed by the displays at predetermined image-forming positions; and a light-condenser for individually condensing the images to N observing positions that correspond to the N viewing points, the light-condenser being disposed at the image-forming positions at which the N images are formed. The light-condenser is a transmission-type or reflection-type hologram screen having a function of diffracting and condensing images formed by the lenses to the N observing positions, and arrival positions of rays of light whose direction remains unchanged by the light-condenser do not coincide with the observing positions.

According to an embodiment of the present invention, there is provided a three-dimensional display apparatus including: displays for displaying N images of different viewing points; lenses for forming the N images displayed by the displays at predetermined image-forming positions; and a light-condenser for individually condensing the images to N observing positions that correspond to the N viewing points, the light-condenser being disposed at the image-forming positions at which the N images are formed. The lenses forms images of the N viewing points from N different positions to the light-condenser. Further, the light-condenser includes a recursive reflection-type screen for recursively reflecting each image formed by the lenses, and a half mirror for condensing the recursively reflected image to the N observing positions, the half mirror being disposed between the lenses and the recursive reflection-type screen.

### BRIEF DESCRIPTION OF THE DRAWINGS

The above and other objects, features and advantages of the present invention will become more apparent from the following description of the presently preferred exemplary embodiment of the invention taken in conjunction with the accompanying drawing, in which:

FIG. 1 is a schematic plan view of a 3D display apparatus according to a first embodiment;

FIG. 2 is a schematic representation of an example showing image display parts of a 3D image display apparatus according to a first embodiment;

FIG. 3A to FIG. 3C show diagrams explaining the principle of diffraction on a hologram screen;

FIG. 4 is a schematic side view of a 3D display apparatus according to a first embodiment;

FIG. 5 is a schematic plan view of a 3D display apparatus according to a second embodiment;

FIG. 6 is a schematic plan view of a 3D display apparatus according to a third embodiment;

FIG. 7 is a schematic illustration of a recursive reflection-type screen of a mirror type;

FIG. 8 is a schematic plan view of a 3D display apparatus according to a fourth embodiment; and

FIG. 9 is a graphic representation of a relationship between an incident angle Φ of incident light and its reflection ratio relative to a recursive reflection-type screen.

### DETAILED DESCRIPTION OF THE PREFERRED EMBODIMENTS

Specific embodiments to which the present invention is applied will be described in detail with reference to the drawings. Now, the embodiments to which the present invention is applied is a three-dimensional display apparatus (3D display apparatus) that enables a plurality of observers to simultaneously see a three-dimensional image (3D picture image) and to see a three-dimensional image (3D image) even if the observer moves.

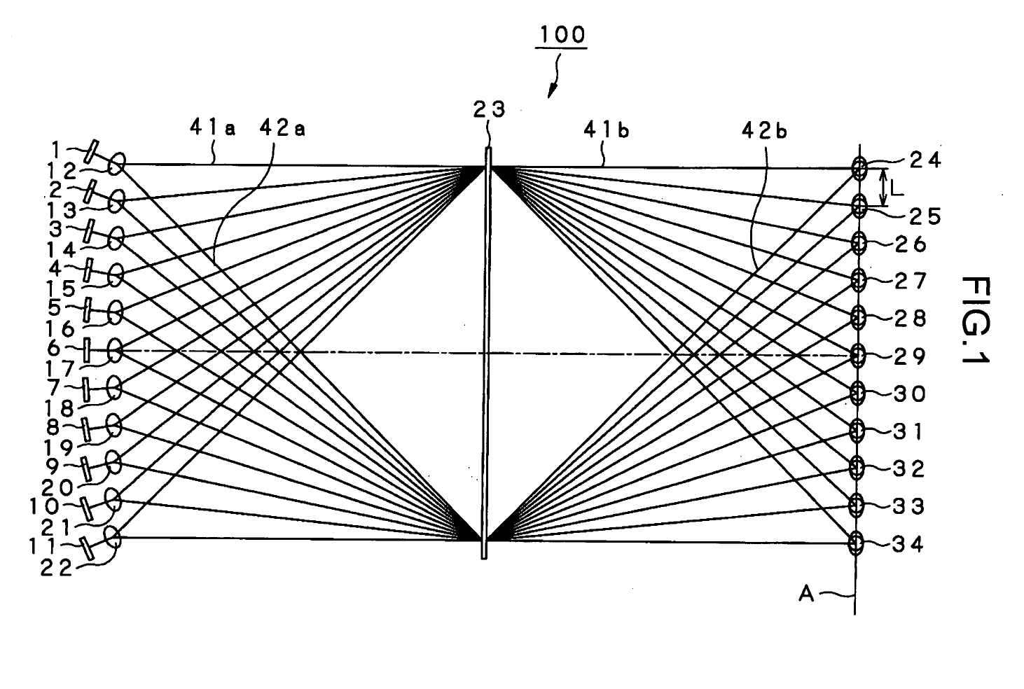

FIG. 1 is a schematic plan view of a 3D display apparatus of a first embodiment according to the present invention, which is viewed from above. The 3D display apparatus 100 according to the first embodiment includes picture image display parts 1-11 for displaying parallax pictures (parallax images) of a plurality of viewing points (N points), lenses 12-22 that are image-forming means for forming each picture image from the picture image display parts 1-11, respectively, and a hologram screen 23, which serves as light-condensing means for diffracting and condensing picture images (light) formed through lenses 12-22 to a plurality of observing positions corresponding to a plurality of viewing points for performing condensing action and polarizing action. The observing positions are disposed on the opposite side of the picture image display parts 1-11 with having the screen 23 in between, on a plane (hereinafter may also be referred to as “observation plane”) approximately parallel to the screen 23.

The picture image display parts 1-11 are, for example, transmission-type liquid crystal displays (LCDs) or the like. In this example, 11 picture image display parts are shown herein. Alternatively, any necessary number of subparts maybe placed. For example, in a case of a transmission-type LCD, a light source (backlight) (not shown in the figure) is provided for each of the picture image display parts 1-11. By means of a picture image displayed on the LCD of each of the picture image display parts 1-11, light from each light source is modulated to form an image through the lenses 12-22, which serve as image-forming means, at the same position on the screen 23. The picture image displayed on each of the picture image display parts 1-11 is a picture image of an object such as the same object or scenery photographed from respectively different camera positions or angles (viewing points).

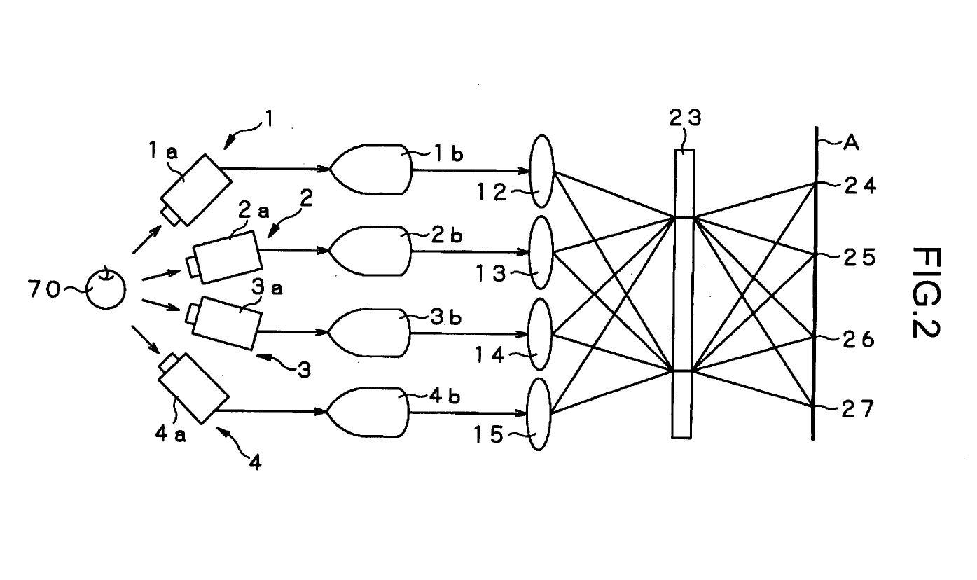

Further, in a case where the picture image display parts 1-11 are CRTs (cathode-ray tubes), as shown in FIG. 2, image-capturing means 1a-11a (only image-capturing means 1a-4a are illustrated in FIG. 2) such as a camera are installed in following stages. Picture images such as one object 70 or scenery, which are captured by the image-capturing means 1a-11a from different angles or positions, are displayed by the CRT 1b-11b (only CRT 1b-4b illustrated in FIG. 2), and the display light is used for image-forming by the lenses 12-22 (only lenses 12-15 are illustrated in FIG. 2) at the same image-forming position on the screen 23.

The screen 23 is, for example, a transmission-type hologram screen, diffracting and condensing each picture image formed by the lenses 12-22. Each of these picture images is taken from a different viewing point and being condensed at the observing positions 24-34, each of which corresponds to each picture image mentioned above. The observing positions are positioned on the observation plane A in FIG. 1 that is parallel to the screen 23.

Namely, in FIG. 1, a picture image from the picture image display part 1 is subjected to the image-forming on the screen 23 by the lens 12 which serves as the image-forming means of the picture image display part 1, diffracted by the screen 23, and condensed to an observing position 24. More specifically, a ray of light 41a from the picture image display part 1 is diffracted by the screen 23 and become a ray of light 41b, while a ray of light 42a is diffracted by the screen 23 and become a ray of light 42b. These rays of light are condensed to the observing position 24. Likewise, an image of the picture image display part 2 is diffracted by the screen 23 and condensed to the observing position 25, while respective images of the picture image display parts 3-11 are condensed to the corresponding observing positions 26-34.

In the observing positions 24-34, a parallax picture image, which would become an image of a certain viewing point corresponding to either one of the observer's eyes, is observed. That is, in the picture image display part 1, a parallax picture image for the observing position 24 or a picture image at a virtual camera position corresponding to the observing position 24, which is generated or captured, is displayed. Similarly, in the picture image display part 2, a parallax picture image for the observing position 25, which is generated or captured, is displayed. Likewise, in the picture image display parts 3-13, parallax picture images for respective observing positions 24-34, which are similarly generated or captured, are displayed. Accordingly, at the observing positions 24-34, in case that the right eye of the observer is located at the observing position 24 and the left eye is located at the observing position 25, the observer is able to see a 3D picture image at the observing positions 24-25 which become the observer's viewing points. That is, the viewing point of each picture image and the observing position are spatially related in relative terms. It should be noted that a picture image generating part or the like may be set up to generate a parallax picture image to be displayed at each of the display parts 1-11, thereby supplying a generated parallax picture image to each of display parts.

In the present embodiment, it is preferable that a gap between adjacent observing positions, for example, between the observing positions 24 and 25, is set to be smaller than a gap between the human eyes. When making the gap between the adjacent observing positions narrower than the gap between the human eyes. For example, such a gap may be set to equal to or a half the gap between the human eyes. By setting up the gap in this way, even if the observer moves his head to such an extent that a position of the right eye moves to a position that used to be the left eye position and a position of the left eye moves to the adjacent observing position 26, the observer is able to see a 3D picture image at the observing positions 25-26 which become new viewing points. In the present embodiment, picture images to be displayed at the picture image display parts 1-11 are so controlled that a picture image that can be viewed from the observing positions 25-26 is a picture image of the object, which is seen from a viewing point positioned slightly to the left in comparison with the observing positions 24-25. Namely, each of the picture images displayed at the picture image display parts 1-11 is a picture image of the same object or scenery and is captured at a different camera position, or generated as if it is captured at a different camera position. The picture images are condensed by means of the screen 23 to the corresponding observing positions 23-34 that satisfies the same spatial relation as those camera positions in relative terms. In this manner, for example, as shown in FIG. 1, by setting up these 11 observing positions, the observer is allowed to see 3D picture images from 10 different viewing points that are arranged as consecutive observing positions 24 to 34.

By subjecting a diffraction angle of the screen 23 to optimum design, the degree of light condensing at each viewing point position may be optimized. As a result, a 3D picture image may be seen from any arbitrary position as long as the eye position lies in between the observing positions 23-34.

In order to form the screen 23, for example, in form of a transmission-type hologram screen, a dry plate may be exposed a plurality of times to produce single hologram. The dry plate may be formed by coating a substrate consisting of a glass or plastic with gelatinous silver salt or bichromated gelatin or the like. Alternatively, the screen may be formed by overlaying layers of holograms having different diffraction angles for use of corresponding observing positions.

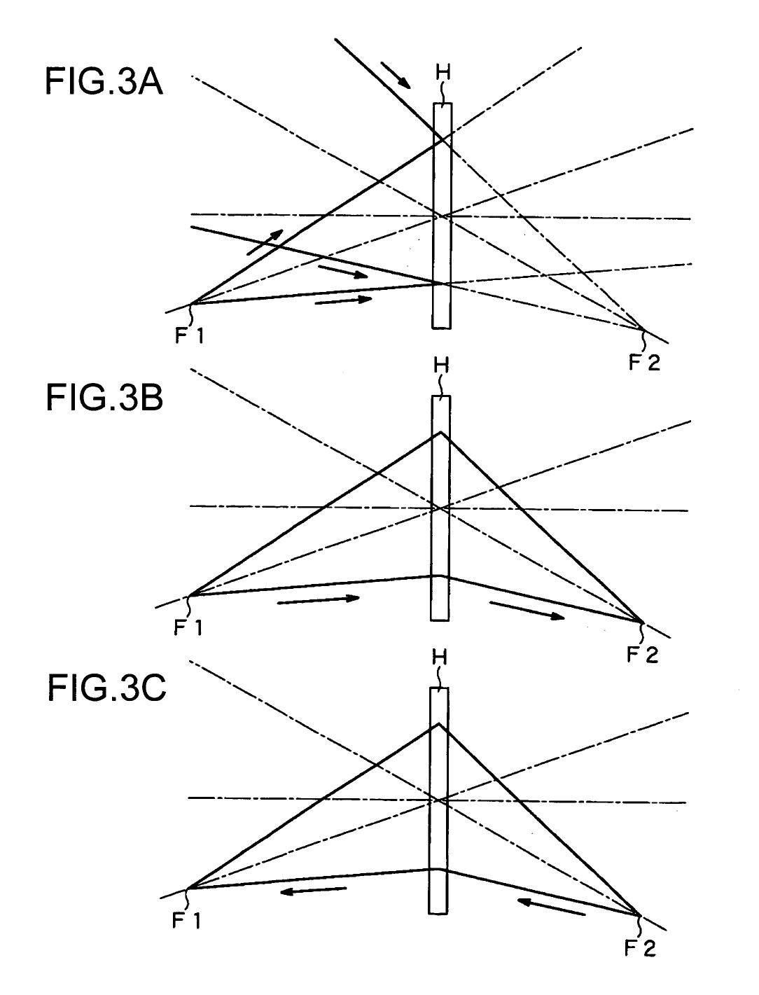

FIG. 3A to 3C are diagrams explaining the principle of diffraction in the hologram screen. Generally speaking, in order to make a hologram, two wave fronts of reference light and object light are radiated on a recording material to produce interference fringes. As a combination of the reference light and the object light, simple combinations may include a combination of a spherical wave and a spherical wave, a combination of a planar wave and a spherical wave, a combination of a planar wave and a planar wave, and the like. These combinations mean that regeneration of a spherical wave from a spherical wave, a planar wave from a spherical wave, and a planar wave from a planar wave, respectively. For example, as shown in FIG. 3A, a spherical wave (divergent light), which passes through a hologram screen H and converges at a focal point F2, is generated and radiated onto the hologram screen H. On the other hand, a point light source is positioned at an acting focal point position F2 to be obtained, for example, by means of an objective of a microscope, a spatial filter and the like. The spherical wave is generated from the point light source and radiated onto the hologram screen H. On the hologram screen H, there is recorded a hologram by the spherical wave condensing to F1 and the spherical wave from F2. As shown in FIG. 3B, when the spherical wave from the point F1 is radiated onto the recorded hologram, the spherical wave is diffracted and condensed by the hologram screen H to the point F2. Further as shown in FIG. 3C, when the spherical wave from the point F2 is radiated onto the recorded hologram, the spherical wave is condensed to the focal point F1. The hologram screen according to the present embodiment may be formed by generating a plurality of interference fringes so as to enable a plurality of the picture images (light) from a plurality of picture image display parts to be condensed to different observing positions that are a plurality of condensing points, or by attaching together a plurality of screens having interference fringes.

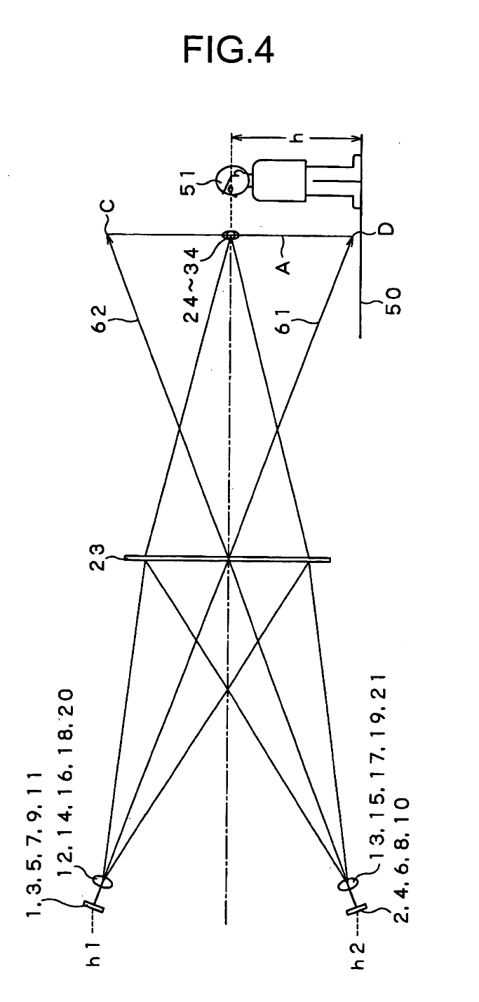

Furthermore, in order to provide a high contrast, sharp image to the observer, it is preferable to employ some measure to prevent 0th light of the light source that passed through the LCD from directly entering the eyes of the observer. FIG. 4 shows a diagram explaining an example of a construction so as to resolve such a situation of the 0th light. FIG. 4 is a side view of the 3D image display apparatus according to the present embodiment as shown in FIG. 1.

Picture images of all the picture image display parts 1-11 are subject to transmission diffraction at the hologram screen 23, whereas, in the vertical direction of an observation plane A, all the picture images are condensed at the same height position from a floor surface 50 at feet. For example, the picture images are condensed at the corresponding observing positions 24-34 at a height h, which is equal to that of the viewing point of the observer 51. Further, as mentioned above, a gap L between the adjacent observing positions in the horizontal direction of the observing positions 24-34 may be, as shown in FIG. 1, set to a value less than the gap between the human eyes. For example, the picture images are condensed on the same horizontal line with having the gap of 62.5 mm or less.

As shown in FIG. 4, for example, the display parts 1, 3, 5, 7, 9, and 11 are provided at a position h1 higher than the viewing point height h with respect to the screen 23, and images from this position h1 are diffracted by the screen 23 to be condensed to the predetermined observing positions on the observation plane A, while the display parts 2, 4, 6, 8, and 10 diffract and condense images from a lower position h2 than the viewing point height h with respect to the screen 23 by means of the screen 23. Namely, the height positions h1 and h2 of the light sources (picture image display parts) are so adjusted that the 0th light may reach a position off the viewing point of the observer 51, for example, higher than the top of observer's head such as a vicinity C of a ceiling (not shown in the figure) or a vicinity D of the floor surface at feet.

Accordingly, of among the rays of light passing through the display parts 1-11 and the screen 23, the 0th rays of light 61 and 62, which are not diffracted by the screen 23 but advance straight, reach the vicinity D of the floor surface at feet of the observer 51 or the vicinity of the ceiling, respectively. Accordingly, the 0th rays of light do not directly enter the eyes of the observer 51, thereby enabling the observer to observe the 3D picture images with high picture quality and multiple viewing points.

According to the present embodiment constructed in the manner described above, a large number of people are allowed to simultaneously observe the 3D picture image by setting up a plurality of observing positions separated by the gap less than the gap between the eyes of an observer. Further, the present embodiment allows to offer different 3 D picture images corresponding to the different viewing points as the observer's viewing point shifts with the movement of the observer. Accordingly, as if looking through one of windows of a building, the observer is able to see a picture image stereoscopically in such a way that if the observer moves to the left, the observer may observe a picture image which would be seen from the left side, and if the observer moves to the right, the observer may observe a picture image from the right side, without flickering thereof which would occurs in conventional methods using the lenticular system or a parallax barrier. Accordingly, the observer may enjoy picture images with ease since it is closer to a case where the observer is observing a 3D object in the real world. Further, the observer may be able to relax and enjoy watching picture images more since it is not necessary to wear any special apparatus such as a 3D glasses. Furthermore, all that is needed is to set up the screen 23 in a following stage of the picture image display parts 1-11. Accordingly, the number of viewing points (observing positions) may be easily increased according to the number of picture images to be displayed by the picture image display parts. Accordingly, the construction according to the present embodiment may be provided in a very simple manner with a further advantage of the ease of setting up and moving the apparatus.

Further, because arrival positions of the 0th rays of light, whose direction remains unchanged at the screen 23, and the observing positions 24 to 34 are different, the observer is allowed to observe picture images of high quality. In the present embodiment, a plurality of observing positions are set up at the same height (on the same horizontal line) on the observation plane A. Alternatively, a plurality of observing positions of different heights may be established on the observation plane A. Accordingly, the observer is allowed to observe parallax picture images while standing or sitting. In addition, not only moving picture images but also still images may be displayed at the picture image display parts.

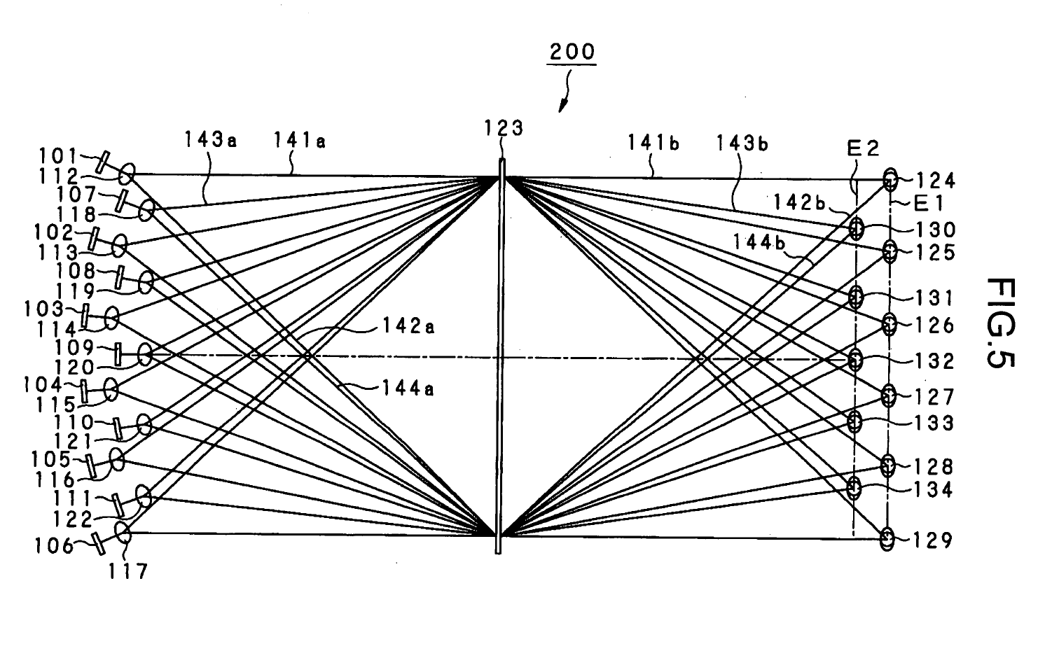

Next, a second embodiment according to the present invention will be described. The second embodiment according to the present invention is a 3D display apparatus which enables an observer to see a 3D image even if the observer comes close to the screen or moves away therefrom. FIG. 5 is a schematic plan view where the 3D display apparatus of the present embodiment is seen from the above.

As shown in FIG. 5, the 3D display apparatus 200 of the present embodiment includes a plurality of picture image display parts 101-111, lenses 112-122 which serve as image-forming means for forming each picture image from the picture image display parts 101-111, respectively, and a hologram screen 123 performing condensing action and polarizing action for diffracting the picture images formed through lenses 112-122 and condensing them to predetermined observing positions.

The lenses 112-122, like the first embodiment of the present invention, form images from the picture image display parts 101-111 on the same position on the screen 123. Further, the screen 123 is, for example, like the first embodiment, a transmission-type hologram screen including a multiple or multi-layer hologram, and diffract and condense each of the picture images formed by the lenses 112-122 to a predetermined position on a predetermined observation plane. At this point in the present embodiment, unlike the first embodiment, observation planes E1 and E2 are provided at different distances from the screen 123 in such a way that these observation planes are disposed parallel to the screen 123. The picture images are condensed to the predetermined positions on these two observation planes E1 and E2.

Specifically, in FIG. 5, a picture image from the picture image display part 101 is formed by the lens 112 on the screen 123, diffracted and condensed by the screen 123 to an observing position 124 on the observation plane E1. Likewise, picture images from the picture image display parts 102-106 are respectively formed by the lenses 112-117 on the screen 123 and condensed to observing positions 125-129 on the observation plane E1. The observing positions 124-129 for images to be condensed to the same observation planes E1 are the observing positions which become viewing points corresponding to either one of the observer's eyes. At these observing positions 124-129, parallax picture images corresponding to respective different viewing points are condensed. As a result, if the right eye of the observer is positioned at the observing position 124, and if the left eye is positioned at the observing position 125, the observer is able to observe a 3D (stereoscopic) picture image related to the viewing points 124-125.

On the other hand, an image of the picture image display part 107 is diffracted by the screen 123 and condensed to an observing position 130 on the observation plane E2 that is closer to the screen 123 than the observation plane E1. Likewise, picture images from the picture image display parts 108-111 are respectively formed by the lenses 119-122 on the screen 123 and condensed to observing positions 131-134 on the observation plane E2. In this manner, in the present embodiment, distances of light, which is diffracted and condensed by the screen 123, from the screen to the observation positions are made different with the provision of a plurality of observation planes.

In the present embodiment, like the first embodiment, it is preferable that a gap between adjacent observing positions on the same observation plane, for instance, a gap between the observing positions 124 and 125 on the observation plane E1, a gap between the observing positions 130 and 131 on the observation plane E2 or the like is set to be less than a gap between human eyes.

For example, if adjacent observing positions on the same observation plane are separated by a distance equal to a gap of both human eyes, the observer may be able to observe a 3D picture image, for example, with the viewing points 130-131 even if the observer move his/her head from a position where the observer is observing a 3D picture image with the observing positions 124-125 on the observation plane E1 to a new position in such a way that the right eye is changed to the position 125 and the left eye is changed to the position l26. The picture image that may be observed at the viewing points 130-131 is, as compared with the observing positions 124-125, becomes a picture image that corresponds to a viewing point slightly closer to an object that is being imaged and positioned to the left.

By providing two observation planes in this way, it is possible to observe 3D picture images from nine viewing points corresponding to the observing positions 124-134 that include different positions in the front-and-back direction. Alternatively, more than three observation planes having different distances from the screen 123 may be provided. Further, the observation planes may not be necessarily to be parallel to each other. Accordingly, the present embodiment allows a plurality of the observers to observe 3D picture images from a plurality of positions. In such alternative configurations, as in the case of the first embodiment, it is preferable to form the picture images from the picture image display parts 101-111 by the lenses 112-122 so as to prevent 0th light, whose direction is not subject to change by the screen 123, from becoming the observing positions 124-134.

According to the present embodiment, in addition to similar advantages achieved by the first embodiment, due to the provision of a plurality of observation planes at different distances, the observer may be allowed to observe 3D picture images even if he/she moves in the front-back direction. For example, if the observer moves forward, a 3D picture image close to an object may be observed.

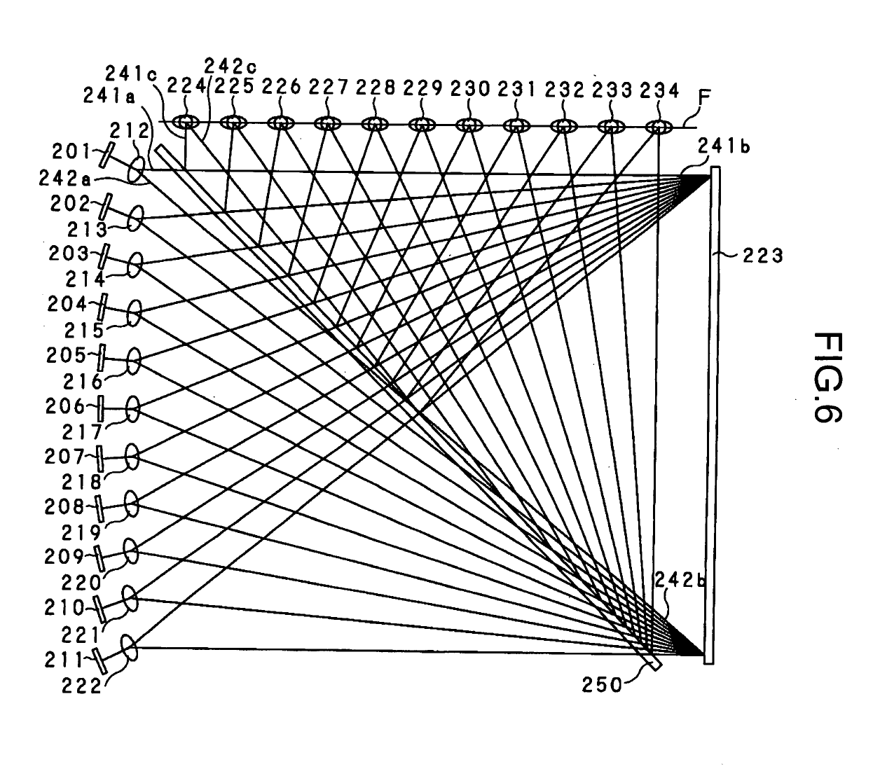

Next, a third embodiment according to the present invention will be described. FIG. 6 is a schematic plan view of a 3D display apparatus of the present embodiment. The present embodiment differs from the above-mentioned first and second embodiments in that a reflection-type screen is used to condense a picture image instead of the transmission-type screen.

As shown in FIG. 6, the 3D display apparatus 300 of the present embodiment includes a plurality of picture image display parts 201-211, lenses 212-222 that serve as image-forming means for forming picture images from a plurality of the picture image display parts 201-211, a screen 223 reflecting picture images (light) formed through the lenses 212-222, and a half mirror 250 reflecting and bending rays of light from the screen 223 and condensing the picture images to predetermined positions.

The picture image display parts 201-211, like the first embodiment, for example, may include transmission-type LCDs or CRTs or the like. In a case of the transmission-type LCDs, a two-dimensional picture image is displayed on each of the picture image display parts 201-211, and light from each backlight is modulated by the displayed picture image and emitted. The light thus emitted is subjected to image-forming by the lenses 212-222, which serve as image-forming means, on a recursive screen 223. Further, if the picture image display parts 201-211 are CRTs, picture images captured by image-capturing means, which are provided in the following stage, are displayed on CRTs, and display light is subjected to image-forming by the lenses 212-222 on the recursive screen 223.

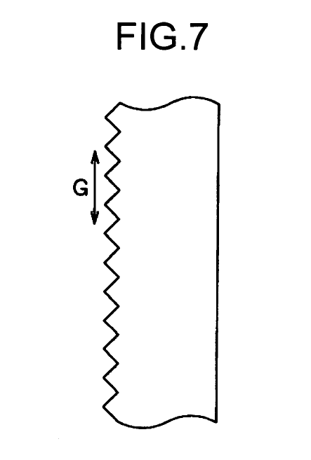

The screen 223 is a recursive reflection-type screen in which reflected light selectively returns in a direction approximately along a light path of incident light. As the recursive reflection-type screen, there are several types such as, for example, a mirror type shown in FIG. 7 or beads type having a reflection layer on the screen 223 with a layer of glass beads printed thereon by screen printing, subjecting each picture image formed by the lenses 212-222 to directional reflection.

On the recursive reflection-type screen of the mirror type shown in FIG. 7, there are disposed a plurality of mirrors whose cross sections have a symmetrical shape of a triangular wave form with an angle of 90° in a direction (direction of arrow G) parallel to a reflection surface of the screen. The plurality of mirrors are thus constructed to provide a function of diffusing light in the direction perpendicular to the paper of the figure. Accordingly, the screen exhibits recursiveness by which light in the direction of arrow G is caused to return to the direction of the light source. Since light diffusion takes place over the direction perpendicular to the paper surface of the figure, the light is reflected in various directions like a typical screen. In other words, the light may be observed both from the front and slantwise, without much appreciable difference in brightness, thereby enabling display of the picture images at the observing positions. This type of mirror may be constructed, for example, by employing the principle of a corner cube or the like. The corner cube is a quadrangular prism having three faces intersecting orthogonally, in which reflected light returns correctly to the direction of incident light even if the position of the prism with respect to the incident light has changed.

The half mirror 250 condenses a picture image subjected to the recursive reflection on the screen 223 to the predetermined position on a observation plane. In the present embodiment, the screen 223 is so placed as to be parallel to a plane on which the picture image display parts 201-211 are disposed, and by means of the half mirror 250 placed between the picture image display parts 201-211 and the screen 223, a picture image is condensed to the predetermined observing position on an observation plane F which is orthogonally intersecting with the screen 223.

Specifically, in FIG. 6, a picture image from the picture image display part 201 is formed on the screen 223 by the lens 212 which serves as image-forming means of the picture image display part 201, recursively reflected by the screen 223, and condensed by the half mirror 250 to the observing position 224. More specifically, a ray of light 241a from the picture image display part 201 is recursively reflected by the screen 223 and becomes a ray of light 241b which becomes a ray of light 241c by the half mirror 250 and condensed to the observing position 224. Further, a ray of light 242a from the picture image display part 201 is recursively reflected by the screen 223 and becomes a ray of light 242b which becomes a ray of light 242c by the half mirror 250 and condensed to the observing position 224.

In the present embodiment, like the previous embodiments of the present invention, the observing positions 224-234 are separated from one another with having approximately the same interval on the observation plane F, and gaps between the observing positions are adjusted to be approximately the same as a gap between eyes of an observer. As mentioned above, a picture image displayed by the picture image display part 202, which is positioned adjacent to the left side of the picture image display part 201, displays a picture image which has parallax difference for an amount of distance equal to a gap between the eyes of the observer from the picture image displayed by the picture image display part 201. Accordingly, it is possible to provide a picture image displayed by each of the picture image display parts 201-211 with a proper parallax.

In other words, parallax picture images for respective observing positions 224-234 are displayed by the picture image display parts 201-211. For example, if the right eye of the observer is located at the observing position 224 and the left eye is located at the observing position 225, the observer is able to view a 3D (stereoscopic) picture image at the viewing point positions 224-225. If the observer moves his/her head in such a way that the right eye is located at the observing position 225 and the left eye is located at the observing position 226, which is one position to the left of the observing position 225, the observer is able to view a 3D picture image at the viewing point positions 225-226. That is, the image of an object seen at the viewing points which is shifted by single gap, which corresponds to a gap between the eyes of the observer, to the left as compared with the observing positions 225-226. In this manner, by setting up eleven observing positions from the observing positions 224 to 234, it is possible to observe 3D picture images at ten viewing points.

Because the present embodiment is constructed the way described above and the recursive reflection screen in conjunction with the half mirror is adapted to condense picture images corresponding to different viewing points to different observing positions, which correspond to the respective viewing points, it has an advantage of making the size of the 3D display apparatus compact as compared with the above-mentioned first and second embodiments.

Further, in a similar way to the above-mentioned first and second embodiments, the present embodiment permits a large number of people to view 3D picture images simultaneously while the present embodiment is capable of providing different 3D picture images corresponding to the viewing points as the observer moves and thus cause the viewing points of the observer to move with his/her movement. Accordingly, it is possible for the observer to observe a picture image stereoscopically as if he/she is looking through one of windows in a building. In other words, if the observer moves to the left, he/she can see a picture image that would be seen from the left, and if he moves to the right, he can see a picture image that would be seen from the right, whereby a 3 D picture image may be observed with more natural sense and relaxed manner.

Next, a fourth embodiment according to the present invention will be described. In the present embodiment, like the third embodiment, a recursive reflection-type screen is employed. One of differences from the previous embodiment is in that a spatial arrangement is modified to improve irregularity of brightness of a picture image.

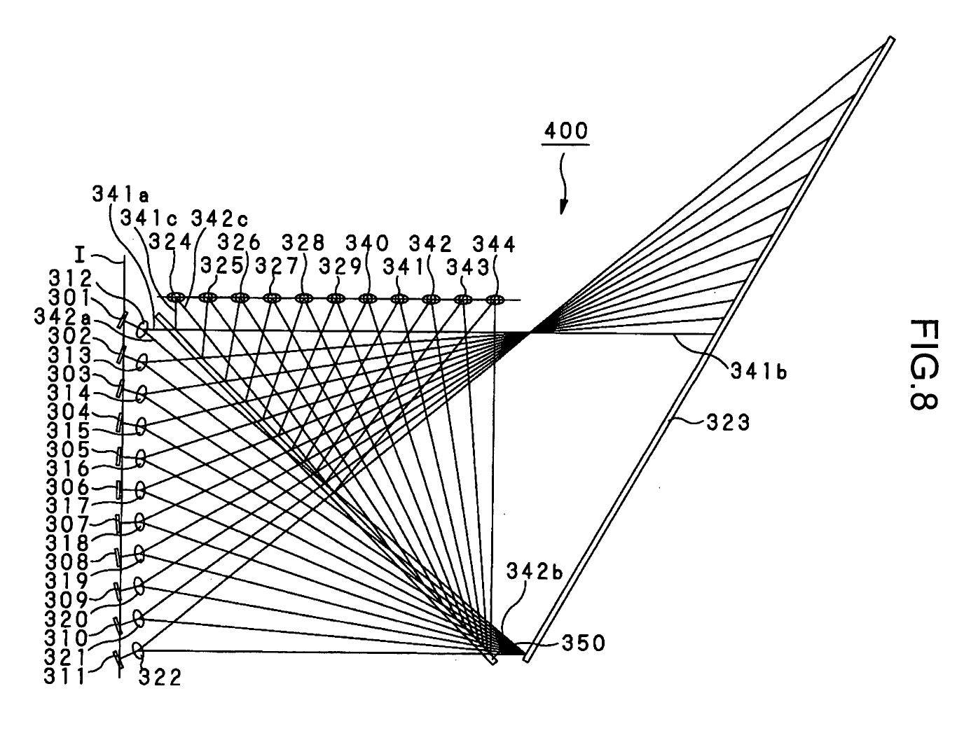

FIG. 8 is a schematic plan view of a 3D display apparatus of the present embodiment. As shown in FIG. 8, the 3D display apparatus 400 of the present embodiment includes a plurality of picture image display parts 301-311, lenses 312-322 which serve as image-forming means for forming picture images from the plurality of picture image display parts 301-311, respectively, a screen 323 reflecting picture images (light) formed through the lenses 312-222, and a half mirror 350 reflecting and bending rays of light from the screen 323 and condensing the picture images to predetermined positions. In this arrangement, it is preferable to have a large incident angle Φ of picture images (light) formed by the lenses 312-322 (an angle between the normal line of the screen and a ray of light) relative to the recursive reflection-type screen 323. Specifically, it is preferable to have an angle in a range 45°<Φ<90°, thereby making it possible to considerably reduce the irregularity of brightness of picture images observed.

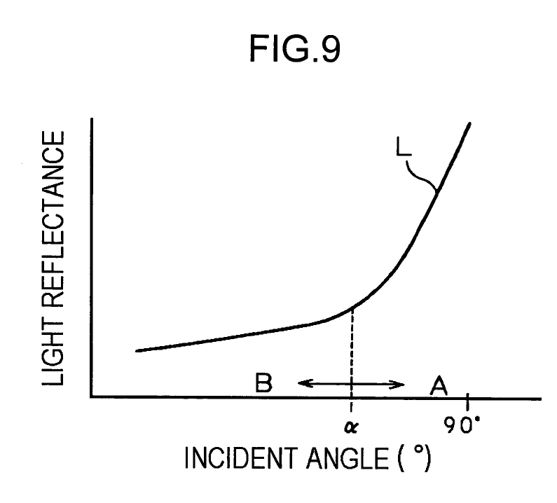

Reasons of such reduction will be described below. FIG. 9 is a graphical representation of a relationship between the incident angle Φ of the incident light and its reflection ratio of the recursive reflection-type screen. As FIG. 9 shows, performance of a recursive reflection-type screen is demonstrated by a curve L indicating a relation between an angle formed by a screen and a ray of light incident on the screen (90°−an incident angle Φ) and an optical reflection ratio of light reflected from the screen. The optical reflection ratio is large in the vicinity of the incident angle of Φ=0°. If the incident angle Φ is made larger by arranging light to enter slantwise to the screen, then the optical reflection ratio falls, causing a change in the reflection ratio with respect to a change in the incident angle (reflection ratio gradient) to be less steep. In other words, in a region A which is less than θ=90°−incident angle Φ=α, because of a large reflection gradient in the curve L, the irregularity of brightness tends to occur more, whereas in a region B which has a larger α, the irregularity of brightness occurs less because of a small reflection gradient in the curve L.

As mentioned above, if a plurality of the picture image display parts 301-311 are disposed on a picture image emitting plane I, the recursive reflection-type screen may enable picture images to be reproduced at the observing positions 324-334 since it has a characteristic of reflecting rays of light along the incident direction even if, like the present embodiment, the recursive transmission-type screen is placed slantwise to the picture image emitting plane I, or even if, like the third embodiment, the recursive transmission-type screen is placed at a parallel position opposite the picture image emitting plane I.

According to the screen having such recursiveness, if the reflection property shown in FIG. 9 is employed to enlarge an incident angle of light relative to the screen 323 (reducing an angle between a ray of light incident on the screen 323 and the screen 323) by inclining a plane parallel to the picture image emitting plane I, it is possible to use reflected light of the region B with less steep reflection gradient and smaller angular dependency. Accordingly, it is possible to improve the irregularity of brightness at the observing positions 324-334. For achieving such advantages of reducing the irregularity of brightness by utilizing reflected light of the region A having such small reflection gradient, it is preferable to satisfy condition of 45°< incident angle Φ<90°, or such that α is less than 45°.

It should be pointed out that, when placing the screen 323 slantwise and not parallel to the picture image emitting plane I, as the screen 323 illustrated in FIG. 8, it is not necessary to be perpendicular to the paper surface of the figure. For example, the screen 323 may be positioned in a three-dimensional slantwise way in which the screen 323 is twisted relative to the picture image emitting plane I.

In the present embodiment, in addition to the similar advantages as in the third embodiment, it is possible to obtain reflected light of the region having smaller dependency on the incident angle, thereby greatly reducing the irregularity of brightness by placing the recursive reflection-type screen 323 in the direction so as to cause the incident angles from the lenses 312-322, which serve as the image-forming means, to become larger so that the incident angles to the screen 323 relative to the picture image emitting plane I may increase, and by making the incident angles of the picture images (light) relative to the recursive reflection-type screen 323 as small as possible.

It should be understood by those skilled in the art that various modifications, combinations, sub-combinations and alterations may occur depending on design requirements and other factors insofar as they are within the scope of the appended claims or the equivalents thereof.

What is claimed is:

1. A three-dimensional display apparatus comprising: displaying means for displaying N images of different viewing points;
image-forming means for forming said N images displayed by said displaying means at predetermined image-forming positions; and
light-condensing means for individually condensing said images to N observing positions that correspond to said N viewing points, said light-condensing means being disposed at said image-forming positions at which said N images are formed, wherein
said light-condensing means is a transmission-type or reflection-type hologram screen having a function of diffracting and condensing images formed by said image-forming means to said N observing positions, and
arrival positions of rays of light whose direction remains unchanged by said light-condensing means do not coincide with said observing positions.

2. The three-dimensional display apparatus according to claim 1, wherein said N is three or more.

3. The three-dimensional display apparatus according to claim 1, wherein said images of said N viewing points are images of an same object captured from N different viewing points.

4. The three-dimensional display apparatus according to claim 1, wherein said light-condensing means comprises a hologram screen comprising a multiple hologram or a multi-layered hologram.

5. The three-dimensional display apparatus according to claim 1, wherein said light-condensing means condenses said picture images to predetermined observing positions on a predetermined observation plane.

6. The three-dimensional display apparatus according to claim 5, wherein said predetermined observation plane is a plane that is substantially parallel to said light-condensing means.

7. The three-dimensional display apparatus according to claim 5, wherein
said predetermined observation plane is substantially parallel to said light-condensing means, and comprises a plurality of planes parallel to said light-condensing means, and
distances between said light-condensing means and said plurality of planes are different from each other.

8. The three-dimensional display apparatus according to claim 5, wherein a gap between two or more observing positions of said N observing positions is substantially equal to a gap between eyes of a human being, said two or more observing positions being positioned on the same horizontal line of the same observation plane.

9. A three-dimensional display apparatus comprising: displaying means for displaying N images of different viewing points;
image-forming means for forming said N images displayed by said displaying means at predetermined image-forming positions; and
light-condensing means for individually condensing said images to N observing positions that correspond to said N viewing points, said light-condensing means being disposed at said image-forming positions at which said N images are formed, wherein:
said image-forming means forms images of said N viewing points from N different positions to said light-condensing means,
said light-condensing means comprises a recursive reflection-type screen for recursively reflecting each image formed by said image-forming means, and a half mirror for condensing said recursively reflected image to said N observing positions, said half mirror being disposed between said image-forming means and said recursive reflection-type screen.

10. The three-dimensional display apparatus according to claim 9, wherein said N is three or more.

11. The three-dimensional display apparatus according to claim 9, wherein said images of said N viewing points are images of an same object captured from N different viewing points.

12. The three-dimensional display apparatus according to claim 9, wherein said recursive reflection-type screen is inclined in relation to a plane on which said image-forming means is disposed in a direction in which an incident angle from said image-forming means increases.

13. A three-dimensional display apparatus comprising:
displays for displaying N images of different viewing points;
lenses for forming said N images displayed by said displays at predetermined image-forming positions; and
a light-condenser for individually condensing said images to N observing positions that correspond to said N viewing points, said light-condenser being disposed at said image-forming positions at which said N images are formed, wherein:
said light-condenser is a transmission-type or reflection-type hologram screen having a function of diffracting and condensing images formed by said lenses to said N observing positions, and
arrival positions of rays of light whose direction remains unchanged by said light-condenser do not coincide with said observing positions.

14. A three-dimensional display apparatus comprising:
displays for displaying N images of different viewing points;
lenses for forming said N images displayed by said displays at predetermined image-forming positions; and
a light-condenser for individually condensing said images to N observing positions that correspond to said N viewing points, said light-condenser being disposed at said image-forming positions at which said N images are formed, wherein:
said lenses forms images of said N viewing points from N different positions to said light-condenser, and
said light-condenser comprises a recursive reflection-type screen for recursively reflecting each image formed by said lenses, and a half mirror for condensing said recursively reflected image to said N observing positions, said half mirror being disposed between said lenses and said recursive reflection-type screen.
